(19) United States
(12) Patent Application Publication
(10) Pub. No.: US 2011/0252937 A1
(43) Pub. Date: Oct. 20, 2011

(54) Slitting Machine for Longitudinally Cutting Material Where The Cut is Critical

(76) Inventor: Rudolf Supe-Dienes, Overath (DE)

(21) Appl. No.: 13/087,077

(22) Filed: Apr. 14, 2011

(30) Foreign Application Priority Data
Apr. 14, 2010 (DE) 20 2010 005 010.3

(51) Int. Cl. B26D 7/08

(52) U.S. Cl. 83/176

(57) ABSTRACT

A slitting machine for slitting or longitudinally cutting material, especially fibrous material, where the cut is critical. A cutting arrangement produces a slit or cut that divides a sheet of material, the cutting arrangement comprising an upper blade and a lower blade. A non-cutting tool for producing a cutting channel in a surface of the sheet of material is disposed upstream of the cutting arrangement as viewed in a direction of slitting. The cutting arrangement is adapted to enter the cutting channel and to execute a cut or slit along the cutting channel.

The instant application should be granted the priority date of Apr. 14, 2010 the filing date of the corresponding German patent application 20 2010 005 010.3.

### BACKGROUND OF THE INVENTION

The present invention relates to a slitting machine for slitting or longitudinally cutting material, especially fibrous material, where the cut is critical, and includes a cutting arrangement, comprised of an upper blade and a lower blade, for producing a slit or cut that divides the material.

A slitting machine having the aforementioned features is known from DE 20 2006 017 387 U1. If such a slitting machine is to be used for cutting a material, for example a fibrous and in particular coarsely fibrous material, as a material for which the cut is critical, there is the drawback that the slitting line or line of cut produced by the cutting arrangement, which is provided with an upper blade and an associated lower blade, becomes frayed in conformity with the fiber structure of the material that is to be slit, and therefore such a slitting line is not clean.

It is therefore an object of the present invention to provide a slitting machine of the aforementioned general type in such a way that a clean, smooth slitting line or line of cut results, even when slitting material where the cut is critical.

### BRIEF DESCRIPTION OF THE DRAWING

This object, and other objects and advantages of the present application, will appear more clearly from the following specification in conjunction with the accompanying schematic drawing, in which:

FIG. 1 is a perspective view from above, of one exemplary embodiment of the cutting arrangement of a slitting machine of the present application, including an upper blade and a lower blade, and a non-cutting tool disposed upstream of the cutting arrangement; and

FIG. 2 a further perspective view, from below, of the arrangement shown in FIG. 1.

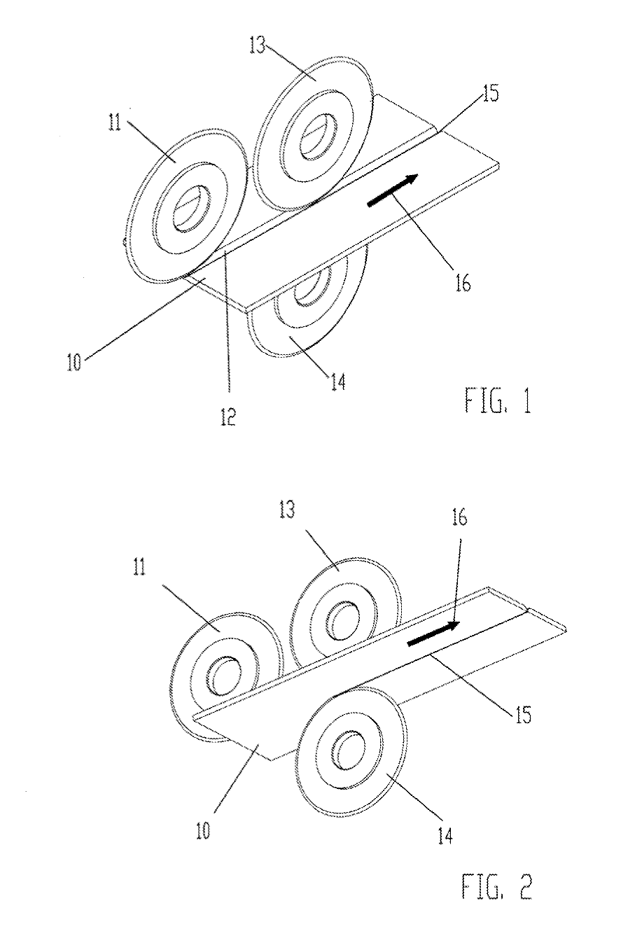

### SUMMARY OF THE INVENTION

The basic concept of the present invention is that a non-cutting tool is disposed upstream of the cutting arrangement, as viewed in the cutting or slitting direction, for producing a cutting channel in a surface of a sheet of material, wherein the cutting arrangement is adapted to enter the cutting channel and to execute the cut or slit along the cutting channel. In this regard, a cutting track or channel is first introduced into the surface of the material that is to be cut by means of the non-cutting tool. If the cut is then executed along the cutting channel by means of the cutting arrangement, which enters or extends into this cutting channel, there results in a surprising and unexpected manner a clean and smooth slit edge.

Pursuant to one exemplary embodiment of the invention, the non-cutting tool can be embodied as a crushing blade, such as is known, for example, from DE 20 2008 001 485 U1. Such a crushing blade is to be disposed on the slitting machine at such a depth adjustment that when the crushing blade is employed, merely the cutting channel is impressed into the surface of the sheet of material, and the crushing blade does not effect a cutting or division of the material. In this regard, it would also be possible to dispense with a lower blade, which is otherwise customary with a crushing blade arrangement. However, the underside of the sheet of material that is contacted by the crushing blade is advantageously supported by an appropriate counter surface.

Alternatively, the non-cutting tool can be embodied as a scoring tool that scores the cutting track or channel into the surface of the sheet of material.

Pursuant to alternative embodiments, the cutting track or channel can also be produced by means of a treatment with ultrasound or a thermal treatment, for which purpose appropriate tools or devices can be provided on the slitting machine.

The cutting arrangement itself can be comprised of an upper blade and a lower blade that in a known manner operate pursuant to the shearing cut principle.

Within the context of such a cutting arrangement, pursuant to a first specific embodiment of the present invention the upper blade of the cutting arrangement can be mounted on a blade holder that in turn is mounted on a crossbar of the slitting machine; the non-cutting tool can be secured to the blade holder and moves together with the upper blade into its cutting position. Such an arrangement ensures that with a view toward the material thickness of the sheet of material that is to be divided, the leading (in operation), non-cutting tool and the upper blade, which executes the slit, always have the same spacing relative to one another, resulting on the one hand in a cutting channel having a defined depth, and on the other hand in a clean cut during division or slitting of the material.

Alternatively, the upper blade of the cutting arrangement can be mounted on a blade holder that in turn is mounted on a crossbar of the slitting machine, while the non-cutting tool is mounted on a separate delivery device that is provided on the slitting machine, so that the employment of upper blade and leading, non-cutting tool can be effected independently of one another and positioning can be appropriately carried out.

Further specific features of the present application will be described in detail subsequently.

### DESCRIPTION OF SPECIFIC EMBODIMENTS

The figures show a sheet of material 10 that is moved in the direction of the arrow 16 and that is to be cut or separated along a slitting line or line of cut 15 by means of a cutting or slitting arrangement that is composed of an upper blade 13 and an associated lower blade 14. Disposed upstream of the arrangement composed of the upper blade 13 and the lower blade 14 is a non-cutting tool or instrument 11, for example in the form of a crushing blade, which is known per se; the tool 11 serves to press a cutting track or channel 12 into the surface, in the illustrated embodiment the upper surface, of the sheet of material 10. The downstream upper blade 13 enters into the cutting channel 12 produced by the tool 11, and in cooperation with the lower blade 14 executes the cut or slit in this cutting channel 12 along the slitting line 15, wherein the shearing cut principle is preferably utilized. Within the framework of such an arrangement, even with a fibrous, in particular coarsely fibrous, material, a clean slitting edge results along the slitting line 15 that is produced.

The features of the subject matter of these documents disclosed in the preceding specification, claims and drawing can be important individually as well as in any desired combination with one another for realizing the various embodiments of the present invention.

The specification incorporates by reference the disclosure of German priority document 20 2010 005 010.3 filed Apr. 14, 2010.

The present invention is, of course, in no way restricted to the specific disclosure of the specification and drawing, but also encompasses any modifications within the scope of the appended claims.

What I claim is:

1. A slitting machine for slitting or longitudinally cutting material for which the cut is critical, comprising:
a cutting arrangement for producing a slit or cut that divides a sheet of material, wherein said cutting arrangement comprises an upper blade and a lower blade; and
a non-cutting tool for producing a cutting channel in a surface of the sheet of material, wherein said non-cutting tool is disposed upstream of said cutting arrangement as viewed in a direction of slitting, and wherein said cutting arrangement is adapted to enter said cutting channel and to execute a cut or slit along said cutting channel.

2. A slitting machine according to claim 1, wherein said non-cutting tool is embodied as a crushing blade that is disposed on said slitting machine at such a depth adjustment that said cutting channel is impressed into the surface of the sheet of material by said crushing blade.

3. A slitting machine according to claim 1, wherein said non-cutting tool is embodied as a scoring tool that scores said cutting channel into the surface of the sheet of material.

4. A slitting machine according to claim 1, wherein said non-cutting tool is embodied as an ultrasound device that introduces said cutting channel into the surface of the sheet of material.

5. A slitting machine according to claim 1, wherein said non-cutting tool is embodied as a thermally operating device that introduces said cutting channel into the surface of the sheet of material.

6. A slitting machine according to claim 1, wherein said cutting arrangement, composed of said upper blade and said lower blade, operates pursuant to the shearing cut principle.

7. A slitting machine according to claim 6, wherein said upper blade of said cutting arrangement is mounted on a blade holder that in turn is mounted on a crossbar of said slitting machine, and wherein said non-cutting tool is secured to said blade holder and moves together with said upper blade into its cutting position.

8. A slitting machine according to claim 6, wherein said upper blade of said cutting arrangement is mounted on a blade holder that in turn is mounted on a crossbar of said slitting machine, and wherein said non-cutting tool is mounted on a separate delivery device that is provided on said slitting machine.
